(19) United States
(12) Patent Application Publication
(10) Pub. No.: US 2016/0109400 A1
(43) Pub. Date: Apr. 21, 2016

(54) SENSOR FOR DETECTING GLUCOSE OF RHIZOME PLANTS

(71) Applicant: EUMED BIOTECHNOLOGY CO., LTD., New Taipei City (TW)

(72) Inventors: Yen-Yuan SHEN, New Taipei City (TW); Chi-Yang PENG, New Taipei City (TW); Tzer-Ming CHEN, New Taipei City (TW)

(21) Appl. No.: 14/519,541

(22) Filed: Oct. 21, 2014

(51) Int. Cl. G01N 27/327

(52) U.S. Cl. CPC G01N 27/3272; G01N 27/3271

(57) ABSTRACT

A sensor for detecting glucose of rhizome plants comprises a substrate, an electrode module, a hydrophobic insulating layer and a cover. The electrode module is arranged on the substrate and includes a measurement portion and a connection section connected with the measurement portion. The hydrophobic insulating layer is disposed on the substrate to cover the measurement portion and the connection section and includes an opening revealing the measurement portion. The cover is disposed on the opening to form a specimen channel between the cover and the substrate. The measurement portion is arranged in the specimen channel. The electrode module includes a working electrode and a reference electrode opposite to the working electrode. The measurement portion of the working electrode has a first exposed region with an area of 4-6 mm² in the specimen channel. Thereby, the present invention can detect the glucose concentrations of juice samples of rhizome plants.

### FIELD OF THE INVENTION

The present invention relates to a glucose sensor, particularly to a sensor for detecting glucose of rhizome plants.

### BACKGROUND OF THE INVENTION

With advance of medical science and development of biomedical industry, the inspections for medical examination, tracking and administration, which can only be undertaken in hospitals before, can also be undertaken at home nowadays. For example, miniature glucose sensors have been widely used nowadays to detect glucose concentration for treatment and prevention of diabetes mellitus, whereby the users (such as the patients of diabetes mellitus) can learn their physiological statuses conveniently and immediately in daily life.

A U.S. patent publication No. US20030203498 disclosed a system for detecting glucose concentrations in blood samples, which comprises a test strip and a measurement meter. The test strip includes a sample chamber, a working electrode, a reference electrode, several fill-detect electrodes, and an auto-on conductor. A reagent layer is disposed in the sample chamber. While the test strip is inserted into the sample chamber, the auto-on conductor wakes up the measurement meter to undertake a detection process. The measurement meter uses the working electrode and the reference electrode to undertake an initial detection of the blood sample in the sample chamber. Then, the measurement meter calculates the glucose level based on the measured current and the calibration data saved in a removable data storage device associated with the test strip.

However, the test strip of the abovementioned miniature glucose sensors can only detect the glucose concentration of blood samples. In other words, it cannot detect the glucose concentration outside the distribution range of the glucose concentration of ordinary blood samples. A non-blood sample, such as a juice sample of a rhizome plant, normally has a trace amount of glucose whose concentration is lower than the glucose concentration of an ordinary blood sample. Therefore, the conventional miniature glucose sensors cannot detect glucose concentrations of juice samples and is limited in application.

### SUMMARY OF THE INVENTION

The primary objective of the present invention is to solve the problem that the conventional glucose sensor cannot test the glucose concentrations of the juices of rhizome plants but can only test the glucose concentrations of blood samples.

To achieve the abovementioned objective, the present invention proposes a sensor for detecting glucose of rhizome plants, which comprises a substrate, an electrode module, a hydrophobic insulating layer and a cover. The electrode module is arranged on the substrate and includes a measurement portion and a connection section connected with the measurement portion. The hydrophobic insulating layer is disposed on the substrate to cover the measurement portion and the connection section and includes an opening revealing the measurement portion. The cover is disposed on the opening to form a specimen channel between the substrate and the cover. The specimen channel includes a specimen inlet formed on a circumference of the substrate and a blocking end opposite to the specimen inlet and blocked by the hydrophobic insulating layer. The measurement portion is arranged between the specimen inlet and the blocking end.

The electrode module includes a working electrode and a reference electrode. The measurement portion of the working electrode has a first exposed region with an area of 4-6 mm² in the specimen channel.

In the present invention, the first exposed region of the measurement portion of the working electrode is designed to have an area of 4-6 mm². After the specimen of a juice specimen of a rhizome plant is injected into the specimen channel, the first exposed region is enough to contact a sufficient amount of the trace glucose in the juice specimen for detecting the glucose concentration thereof. Thus, the present invention can detect the glucose concentration of a juice specimen of a rhizome plant sensitively.

### BRIEF DESCRIPTION OF THE DRAWINGS

FIG. 1 is a perspective view schematically showing a sensor for detecting glucose of rhizome plants according to one embodiment of the present invention;

FIG. 2 is an exploded view schematically showing a sensor for detecting glucose of rhizome plants according to one embodiment of the present invention; and

FIG. 3 is a top view schematically showing a sensor for detecting glucose of rhizome plants according to one embodiment of the present invention.

### DETAILED DESCRIPTION OF THE PREFERRED EMBODIMENTS

The technical contents of the present invention will be described in detail in cooperation with drawings below.

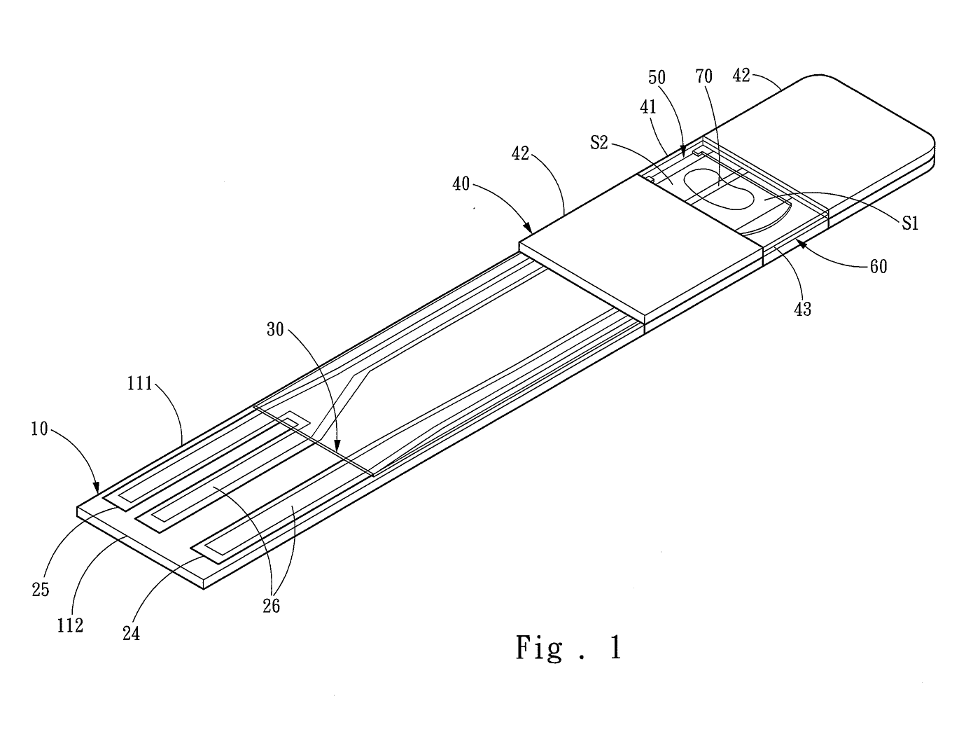

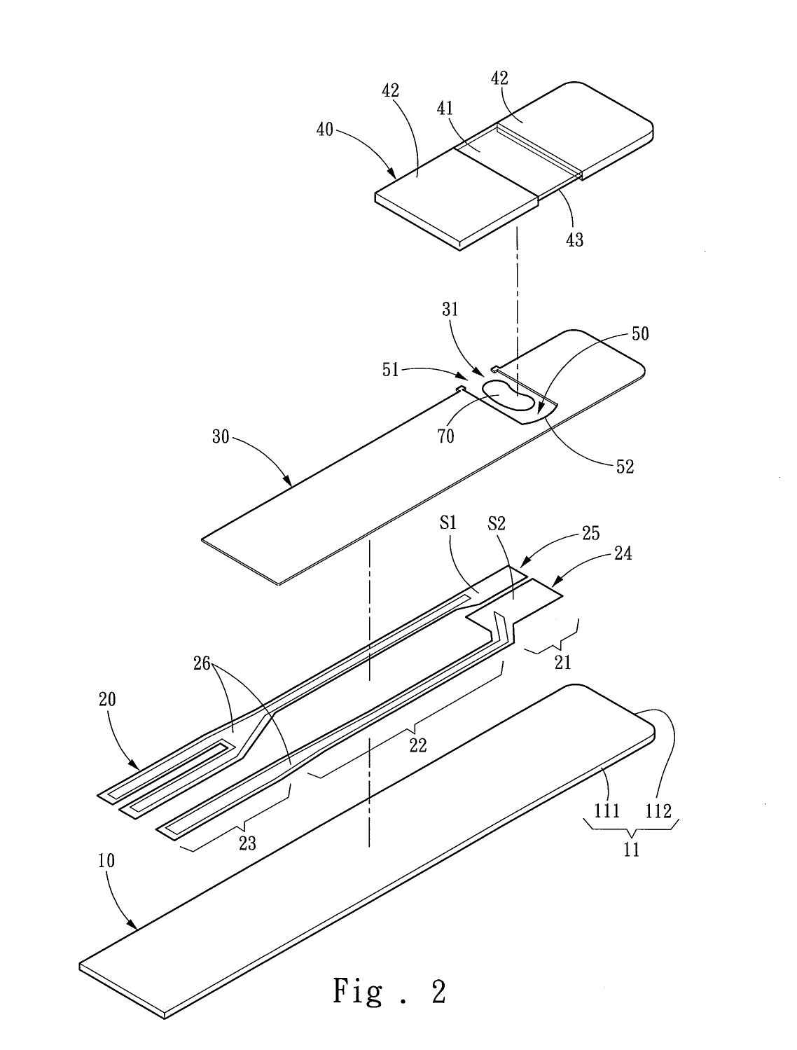

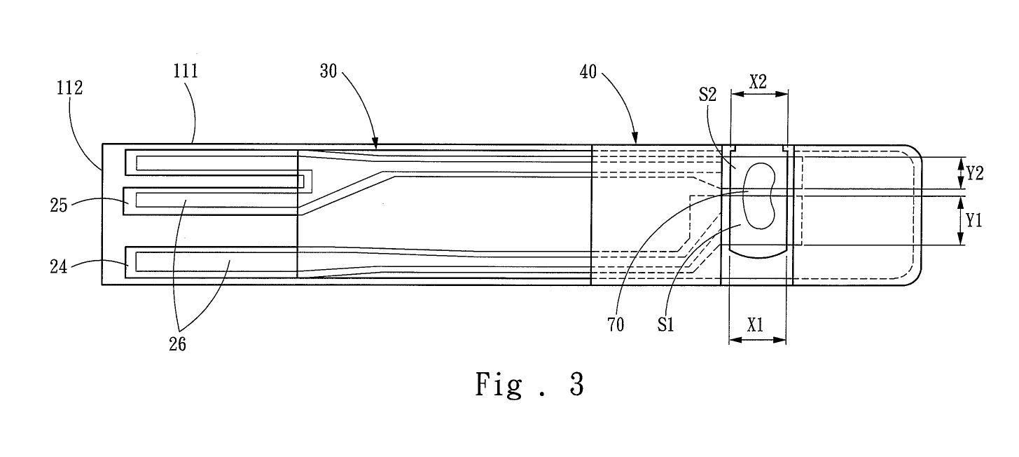

Refer to FIGS. 1-3 respectively a perspective view, an exploded view and a top view schematically showing a sensor for detecting glucose of rhizome plants according to one embodiment of the present invention. The sensor for detecting glucose of rhizome plants of the present invention is used to detect the glucose concentrations of rhizome plants, especially to detect the glucose concentrations of the juice specimens of rhizome plants. The sensor for detecting glucose of rhizome plants of the present invention comprises a substrate 10, an electrode module 20, a hydrophobic insulating layer 30 and a cover 40. The substrate 10 is strip-like and has a circumference 11. The circumference 11 includes two long edges 111 and two short edges 112. The long edges 111 are parallel. The short edges 112 are also parallel and each coupling the two long edges 111. The electrode module 20 is arranged on the substrate 10 and includes a measurement portion 21, a connection section 22, and a signal reading element 23. The measurement portion 21 and the signal reading element 23 are respectively connected with two ends of the connection section 22. The electrode module 20 uses the measurement portion 21 to undertake measurement. The signal reading element 23 is electrically connected with a measurement instrument (not shown in the drawings), which analyzes the signals detected by the measurement portion 21. The electrode module 20 includes a working electrode 24 and a reference electrode 25 arranged opposite to the working electrode 24. Auxiliary electrodes 26 are coated on the connection section 22 and the signal reading element 23 for enhancing electric conduction. In one embodiment, the electrode module 20 is made of an electrically-conductive polymeric material, and the auxiliary electrodes 26 are made of silver paste.

The hydrophobic insulating layer 30 is made of an ordinary hydrophobic material, such as polypropylene. The hydrophobic material may be in form of a coating material, a laminate plate, or a gel. The hydrophobic insulating layer 30 is disposed on the substrate 10 to cover the measurement portion 21 and the connection section 22 of the electrode module 20 on the substrate 10. The hydrophobic insulating layer 30 has an opening 31 revealing the measurement portion 21. In one embodiment, the opening 31 is extended to one of the two long edges 111 of the substrate 10.

The cover 40 is disposed on the opening 31 to form a specimen channel 50 between the cover 40 and the substrate 10. The specimen channel 50 includes a specimen inlet 51 and a blocking end 52. Similarly to the opening 31, the specimen inlet 51 is also extended to one of the two long edges 111 of the substrate 10. The blocking end 52 is opposite to the specimen inlet 51 and blocked by the hydrophobic insulating layer 30. The measurement portion 21 is arranged between the specimen inlet 51 and the blocking end 52.

The cover 40 includes a transparent portion 41, two relief regions 42, and a hydrophilic surface layer 43. The transparent portion 41 is arranged corresponding to the opening 31 and covers the opening 31 to form the specimen channel 50. The two relief regions 42 are respectively arranged at two sides of the opening 31 and connected with the hydrophobic insulating layer 30. The thickness of the relief regions 42 is greater than the thickness of the transparent portion 41. Thus, the transparent portion 41 would not contact the hydrophobic insulating layer 30, and an air aperture 60 is formed between the cover 40 and the blocking end 52. The hydrophilic surface layer 43 is arranged on one surface of the transparent portion 41, which faces the specimen channel 50. In some embodiments, the hydrophilic surface layer 43 is formed via coating the transparent portion 41 with a hydrophilic material, such as a material selected from a group consisting of ethyl cellulose, methyl cellulose, hydroxypropyl cellulose, cellulose acetate, nitrocellulose, polyvinyl pyrrolidone, polysulfone, polyvinylidene fluoride, polyamide and polyimide. In some embodiments, the cover 40 is directly made of a material selected from the abovementioned group, whereby the hydrophilic surface layer 43 is unnecessary in these embodiments.

In the embodiment shown in the attached drawings, the sensor for detecting glucose of rhizome plants of the present invention further comprises a reaction agent film 70 arranged in the specimen channel 50 and connected with the working electrode 24 and the reference electrode 25. The reaction agent film 70 includes several chemical agents, such as an oxidation-reduction agent, a mediator, a buffer salt, and a surfactant. In one embodiment, the reaction agent film 70 includes FAD-dependent glucose dehydrogenase and potassium hexacyano ferrate to implement glucose detection.

In order to enable the liquid specimen to react with the working electrode 24 and the reference electrode 25, the measurement portion 21 of the working electrode 24 has a first exposed region S1 with an area of 4-6 mm² in the specimen channel 50. In one embodiment, the measurement portion 21 of the working electrode 24 has a rectangular first exposed region S1 with first long edges X1 each having a length of 2.3-2.7 mm and first short edges Y1 each having a length of 1.8-2.2 mm. The measurement portion 21 of the reference electrode 25 has a second exposed region S2 with an area of 2.5-4.5 mm² in the specimen channel 50. In one embodiment, the measurement portion 21 of the reference electrode 25 has a rectangular second exposed region S2 with second long edges X2 each having a length of 2.3-2.7 mm and second short edges Y2 each having a length of 1.1-1.6 mm. Thus, a contact area, which is sufficient to detect the glucose concentration of the liquid specimen, exists between the liquid specimen and the measurement portion 21 of the working electrode 24 and the reference electrode 25.

In application, the user drips a liquid specimen into the specimen inlet 51. Because of the air aperture 60 and the hydrophilic surface layer 43, the liquid specimen can fast flow into the specimen cannel 50. Because of the hydrophobic insulating layer 30, the liquid specimen is hard to diffuse into two sides of the specimen channel 50 but would almost wholly move to the measurement portion 21 inside the specimen channel 50. Hence, there is a sufficient contact area of the liquid specimen, the reaction agent film 70 and the measurement portion 21 of the working electrode 24 and the reference electrode 25 for detecting the glucose concentration of the liquid specimen.

In conclusion, the sensor for detecting glucose of rhizome plants of the present invention is characterized in that the measurement portions of the working electrode and the reference electrode respectively possess a first exposed region and a second exposed region, which contact the liquid specimen injected into the specimen channel to form reaction areas, and that the reaction areas are large enough to promote the sensitivity to a level required by a standard in detecting a range of the glucose concentration of a juice specimen of a rhizome plant. Therefore, the present invention possesses utility, novelty and non-obviousness and meets the condition for a patent. Thus, the Inventors file the application for a patent. It will be appreciated if the patent is approved fast. The present invention has been demonstrated in detail with the embodiments described above. However, these embodiments are only to exemplify the present invention but not to limit the scope of the present invention. Any equivalent modification or variation according to the spirit, characteristic or claim of the present invention is to be also included within the scope of the present invention.

What is claimed is:

1. A sensor for detecting glucose of rhizome plants, comprising
a substrate and an electrode module arranged on the substrate, wherein the electrode module includes a measurement portion and a connection section connected with the measurement portion;
a hydrophobic insulating layer disposed on the substrate to cover the measurement portion and the connection section and including an opening revealing the measurement portion; and
a cover disposed on the opening to form a specimen channel between the cover and the substrate, the specimen channel including a specimen inlet formed on a circumference of the substrate and a blocking end opposite to the specimen inlet and blocked by the hydrophobic insulating layer; wherein the measurement portion is arranged between the specimen inlet and the blocking end, and wherein the electrode module includes a working electrode and a reference electrode opposite to the working electrode, and wherein the measurement portion of the working electrode has a first exposed region with an area of 4-6 mm² in the specimen channel.

2. The sensor for detecting glucose of rhizome plants according to claim 1, wherein the first exposed region of the measurement portion of the working electrode is formed at a rectangular shape having first long edges each having a length of 2.3-2.7 mm and first short edges each having a length of 1.8-2.2 mm.

3. The sensor for detecting glucose of rhizome plants according to claim 1, wherein the measurement portion of the reference electrode has a second exposed region with an area of 2.5-4.5 mm² in the specimen channel.

4. The sensor for detecting glucose of rhizome plants according to claim 3, wherein the second exposed region of the measurement portion of the reference electrode is formed at a rectangular shape having second long edges each having a length of 2.3-2.7 mm and second short edges each having a length of 1.1-1.6 mm.

5. The sensor for detecting glucose of rhizome plants according to claim 1, wherein the substrate is strip-like and has a circumference; the circumference includes two parallel long edges and two short edges each coupling the two long edges; the specimen inlet is located on one of two long edges.

6. The sensor for detecting glucose of rhizome plants according to claim 1, wherein the cover includes a transparent portion arranged corresponding to the specimen channel.

7. The sensor for detecting glucose of rhizome plants according to claim 6, wherein the cover includes a hydrophilic surface layer arranged on one surface of the transparent portion which faces the specimen channel.

8. The sensor for detecting glucose of rhizome plants according to claim 1 further comprising a reaction agent film arranged in the specimen channel and connected with the working electrode and the reference electrode.

9. The sensor for detecting glucose of rhizome plants according to claim 8, wherein the reaction agent film includes FAD-dependent glucose dehydrogenase and potassium hexacyano ferrate.
